(19) United States
(12) Patent Application Publication
(10) Pub. No.: US 2010/0133716 A1
(43) Pub. Date: Jun. 3, 2010

(54) METHOD OF FORMING RELIEF STRUCTURES

(76) Inventors: Jurjen F. Winkel, Cambridgeshire (GB); Withelmus T. Huck, Comberton (GB); Ximin He, Beijing (CN)

Correspondence Address: Raymond L. Owens;Patent Legal Staff, Eastman Kodak Company, 343 State Street, Rochester, NY, 14650-2201, US

(21) Appl. No.: 12/621,608

(22) Filed: Nov. 19, 2009

(30) Foreign Application Priority Data
Dec. 1, 2008 (GB) 0821790.3

(51) Int. Cl. B29C 33/40; B05D 3/12; B05D 3/06

(52) U.S. Cl. 264/134; 427/277; 427/510

(57) ABSTRACT

A method of forming a relief pattern on the surface of a substrate comprises the steps of providing a substrate, coating a thin layer of polymeric material onto the substrate, drying the polymeric material to leave residual lateral stress within the material, bringing a patterned stamp into contact with the polymeric material and applying pressure to the stamp such that the polymeric material ruptures patternwise and dewets at the surface of the substrate to form openings in the polymeric layer according to the pattern on the stamp.

### FIELD OF THE INVENTION

This invention relates to a method of forming relief structures, in particular in the field of high resolution patterning of materials, especially polymer.

### BACKGROUND OF THE INVENTION

Thin polymeric films are a fundamental part of many manufacturing processes, playing a role in fabrication (e.g. photoresists) to operation (dielectrics, light emitting layers, sensor films, etc.). Consequently, enormous efforts have been devoted to understanding their fundamental properties and to pattern thin polymer films, especially now that in some instances the thickness of the films and the feature sizes are reaching molecular dimensions. The vast bulk of polymer thin film research and development efforts have employed films at thermodynamical equilibrium. However, non-annealed films containing residual stresses from the preparation of the films by for instance spincasting can be harnessed for generating new patterning technologies. Nanoimprint lithography (NIL) is potentially an extremely powerful technique for rapid large area nanopatterning, especially with the development of roll-to-roll NIL systems. The basic principle involves placing a master with nanoscale topographic features on top of a thin polymer film and subsequently heating the polymer film above the glass transition temperature (Tg) while applying a pressure, so that the polymer flows to fill the relief pattern of the master. When the master is removed, a thin residual layer usually remains beneath the master protrusions. In the case where the material is a mask or the material itself provides some functionality (e.g. electrical conduction) which is differentiated from the substrate, this residual layer needs to be removed by a subsequent etching process (reactive ion etch is commonly used) before the pattern can become functionally useful, and/or ready for subsequent additional processing techniques such as sputtering, electroplating, etching, spin coating, jetting, etc. Residue-free nano- to micronscale trenches have been generated by scribing poly(3-hexylthiophene-2,5-diyl) (rr-P3HT) thin films with an AFM tip, presumably as a result of the release of residual strain in the films, see A. G. Jones, C. Balocco, R. King, A. M. Song, App. Phy L. 2006, 89, 013119, but although the writing speed is faster than in conventional AFM nanolithography (100's microns per second), it is not at a speed suitable for large area manufacture. Furthermore, although P3HT is known to have interesting semiconducting properties, it is an expensive material to use and is not particularly air stable, and thus would not be a preferred choice for a mask material.

Dewetting of thin polymer films at temperatures above glass transition temperature is a well-understood, although often undesirable, phenomenon. The stability of ultrathin polymer films (<100 nm) is governed by weak surface interactions, and forces acting on the thin film can easily destabilize the continuous film leading to dewetting phenomena (film rupture). Depending on the combined effect of the weak forces (van der Waals, hydrogen bonding) films may rupture either by spontaneous dewetting (unstable films) or by nucleation and growth of holes (metastable films). Numerous studies have investigated the role of film thickness, substrate surface energy and nanoscale topography. Nanoscale surface energy patterns lead to local variations of the effective interface potential and concomitant variations in dewetting kinetics, which results in pattern replication in the dewetted films. It should be noted that dewetting studies are normally carried out using polymer films that are heated above the glass transition temperature Tg, below which temperature the polymer chains are in the glassy state and immobile, hence resisting flow.

### Problem to be Solved by the Invention

Nanoimprint lithography typically requires a post imprint etch step (often reactive ion etch) in order to clean the channels of residual material. This process is costly in terms of time, material and energy and may damage the surface of the remaining features, especially where the polymer material imprinted has a desired functionality. Nanoimprint lithography (NIL) also usually requires high temperature and pressure, which may damage the functionality of certain polymeric materials

### SUMMARY OF THE INVENTION

The present invention provides a non-conventional lithographic technique for the fabrication of nanometer-scale features based on pressure-induced local dewetting at temperatures below the glass transition temperature Tg. The approach is based on the presence of residual stresses in non-annealed spincoated polymer thin films, which ordinarily would be a significant contributing factor in thin film instability and a driving force for hole-nucleated dewetting.

A relatively high evaporation rate of solvent during coating processes leads to frozen-in non-equilibrated chain conformations of the polymer, so generating residual stresses within the film. Any internal or external disturbance, e.g. heating, dust particles, film defects, or local mechanical forces acting on the film surface, provides a route for the residual stress to be relieved.

According to the present invention there is provided a method of forming a relief pattern on the surface of a substrate comprising the steps of providing a substrate, coating a thin layer of polymeric material onto the substrate, drying the polymeric material leaving residual lateral stress within the material, bringing a patterned stamp into contact with the polymeric material, applying pressure to the stamp such that the polymeric material ruptures patternwise and dewets at the surface of the substrate to form openings in the polymeric layer according to the pattern on the stamp.

### Advantageous Effect of the Invention

The method of the invention does not leave a residual ‘skim’ layer. Thus there is no need for an additional dry-etching step before metallization or other evaporation processes that could be part of any subsequent device fabrication process. The absence of this etching step may enable use of materials which are normally sensitive to surface treatments.

The method operates under comparatively low pressure and temperature conditions. The method allows the feature size to be controlled not only by the features of the stamp but also by the imprinting temperature and pressure, layer thickness and adhesive strength.

One embodiment of the invention includes adding pinning features to the layer which could further control the size and position of any induced pattern formation by limiting the areas where stress could be released by film rupture and hence providing a compound pattern where features are formed only in the relatively poorly adhered areas. These pinning features could also aid coatability onto the substrate, which ordinarily may suffer from coating defects due to the relatively poor adhesive characteristics required for the dewetting to take place.

Another embodiment would be to include crosslinking agents which could aid adhesion of the patterned polymer film (UV, IR curing or more standard cross-linking agents) which work on a relatively long timeframe relative to the coating and imprinting steps.

### BRIEF DESCRIPTION OF THE DRAWINGS

The invention will now be described with reference to the accompanying drawing in which:

FIGS. 1a and 1b are schematic views of the procedure of dewetting patterning according to the invention;

FIGS. 2a to 2d show scanning electron microscope (SEM) images;

FIG. 3 is a graph illustrating the effects of patterning temperature on dewetting pattern size;

FIG. 4 illustrates line width and hole area as a function of film thickness; and

FIG. 5 shows AFM (atomic force microscopy) images.

### DETAILED DESCRIPTION OF THE INVENTION

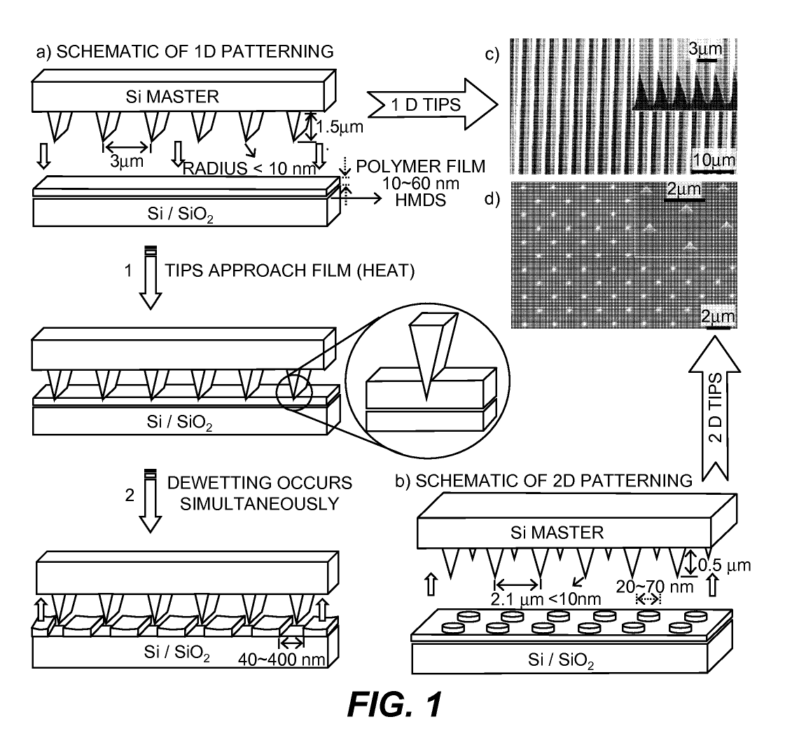

In order to demonstrate the effectiveness of the invention, a number of examples were prepared. The patterning procedure for these is shown schematically in FIG. 1.

Firstly, a fluorinated sharp stamp 8 having a tip array, containing V-shaped edges 2 or cones 4, is placed on top of a spincoated polymer film 3 (10-60 nm thick) on hexamethyldisilazane (HMDS)-treated Si wafers, the substrate 6. The substrate can be of any material having a smooth (planarised) surface to which the polymeric layer has a relatively low adhesion. Preferably the surface of the substrate has an average roughness of 5 nm, more preferably less than 1 nm. The tips are made of silicon. The tips have a length of between 0.5 μm and 1.5 μm and a periodicity of 3 μm. The tip radius is less than a micron. Preferably the tip radius is less than 20 nm, more preferably less than 10 nm. One dimensional V-shaped tips 2 produce lines. Two dimensional conical-shaped tips 4 produce holes. The stamps 8 are brought into contact with the polymer film surface 3 using a pressure of 3 to 5 bars. Under these conditions, the stamp protrusions (‘tips’) do not necessarily penetrate all the way through the film 3 to the substrate 6. After 10-40 seconds, the stamps 8 are lifted away from the film, at which time periodic dewetting patterns are formed, triggered by the local stimulus from the tips. It should be noted that films on HMDS-treated silicon are easily patterned at room temperature, whereas films on untreated silicon require moderate heating, albeit well below the glass transition temperature T_{g}.

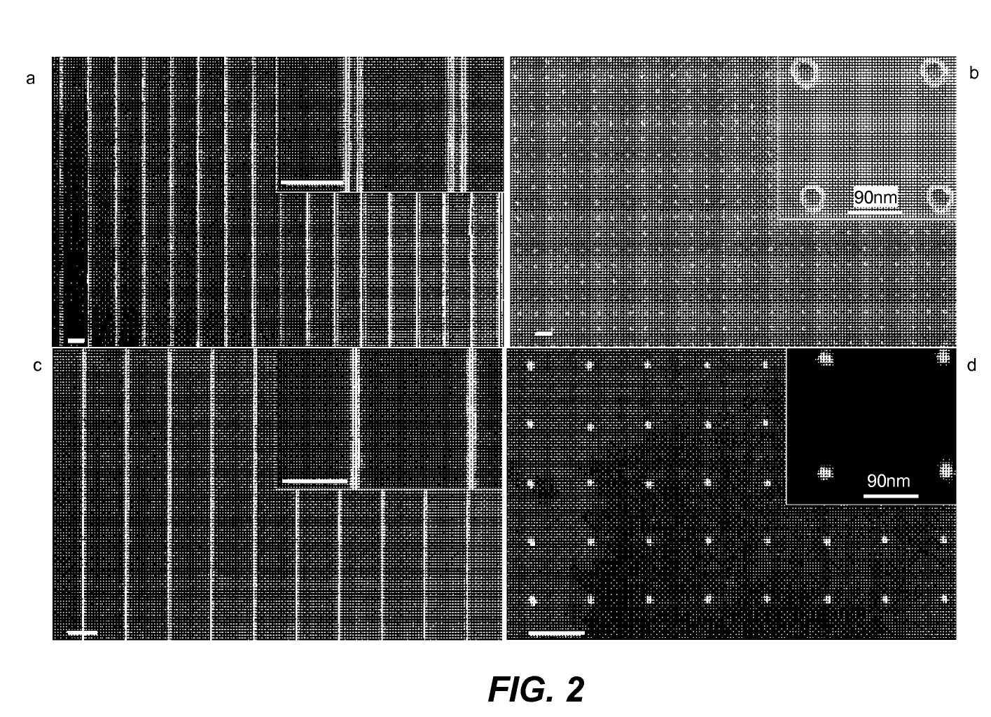

FIG. 2a shows the Scanning Electron Microscope (SEM) image of the line array formed in a 44-nm thick polystyrene (PS, Mw 50 k) film on HMDS-Si by using V-shaped stamps as shown in FIG. 1a. The pattern was very uniform and complete over the whole of the imprinted area (3×3 mm). Clear narrow trenches can be seen in the inset close-up image. Rims at the edges of the trenches are observed, which are typical for polymer film dewetting processes. Similarly, a hole array was formed in PS films on HMDS-Si, using 2D conical-shaped sharp tips, as shown in the SEM image in FIG. 2b. It can be observed in the high-magnification inset image that each dot has a rim surrounding a central pore. In all experiments, both the trenches and the holes are larger than the size of the tip and hence the patterns are not exact negative replicas of the master. This is a strong indication that these patterns are not the result of a standard NIL imprinting process. To examine the patterns in more detail, a thin film of platinum (Pt) was sputtered onto the imprinted films followed by a PS lift-off procedure by soaking and sonicating the samples in toluene. SEM images (FIGS. 2c and 2d) clearly show 59 nm wide Pt lines and 32 nm Pt dots, which indicate that the patterns formed in the imprinting process lead to completely dewetted, residue-free features. In contrast, much thicker films (100 nm) imprinted with the same tips do not show these completely dewetted patterns. Instead, typical imprinted features that replicate the master but leave a thin residual film are observed (results not shown here). An alternative route to pattern formation in these thicker films is based on dewetting triggered by a local mechanical stimulus, which induces a pressure gradient, rupturing the thin polymer film. The ‘holes’ then coarsen by releasing the internal tensile stress of the film. The key to this mechanism are residual stresses within the polymer films, in this case resulting from the spincoating process and fast evaporation of the solvent. Indeed, freshly prepared (non-annealed) thin film that had been stored in an ambient environment tended to form the dewetting pattern more easily in comparison with films that had been vacuum-annealed at 80° C. for 48 hours. The better molecular chain mobility and lowering of the glass transition temperature T_{g} due to some remaining solvent in thin films and the presences of residual stresses after spincoating, as well as the effect on dewetting phenomena, has been documented.

Described below is how the pattern size can be tuned by controlling the film thickness and imprinting temperature, the effect of surface energy and polymer molecular weight.

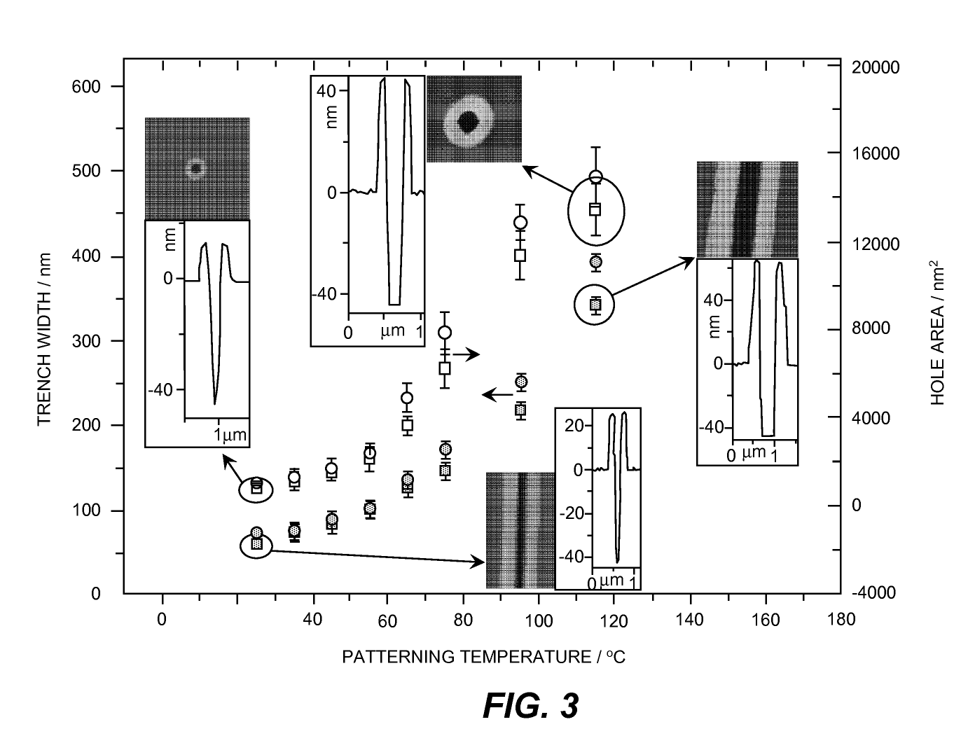

To study the effect of patterning temperature on the dewetting pattern size, a series of examples were prepared at different temperatures. FIG. 3 shows the clear increase in pattern size with increase in imprinting temperature for both 44 nm and 60 nm thick films. The line patterns are plotted as increase in width vs. patterning temperature. Surface area vs. temperature is plotted for the hole patterns, as the sharp conical tips allow the residual stress to be released in two dimensions. By controlling the temperature from 25° C. to 115° C., the average width of trenches in 40 nm-thick PS films can be changed from 59 nm to 341 nm. The average hole areas changed from 804 nm² to 13463 nm². Similarly, the average width of trenches in 60 nm-thick PS films can be changed from 71 nm to 392 nm and the average hole areas changed from 1017 nm² to 14950 nm². The feature sizes increased more pronouncedly at patterning temperatures above 75° C. which is close to the glass transition temperature Tg for a 40-60 nm thin film of PS (70-90° C. as determined by ellipsometry measurements) The AFM images in FIG. 3 show the progression of feature size increases. From the cross sectional profile of the AFM we can observe closely the rims around the imprinted features and rim heights increase with the increase of feature sizes. Close agreement between the reorganized rim volume and the volume of the trench or hole implies that the transformation involves mostly mass transport without removal of material.

FIG. 3 illustrates the effects of patterning temperature on dewetting pattern size. The inserts show AFM topography images and cross-section profiles of the patterns, corresponding to the indicated dots in the plot of pattern size vs. patterning temperature. Trenches in 44 nm-(▪) and 60 nm-() PS films (Mw 50 k) in trench width (left axis), holes in 40 nm-(□) and 60 nm-(◯) PS films in hole area (right axis) were produced by conducting the dewetting patterning approach at different patterning temperatures.

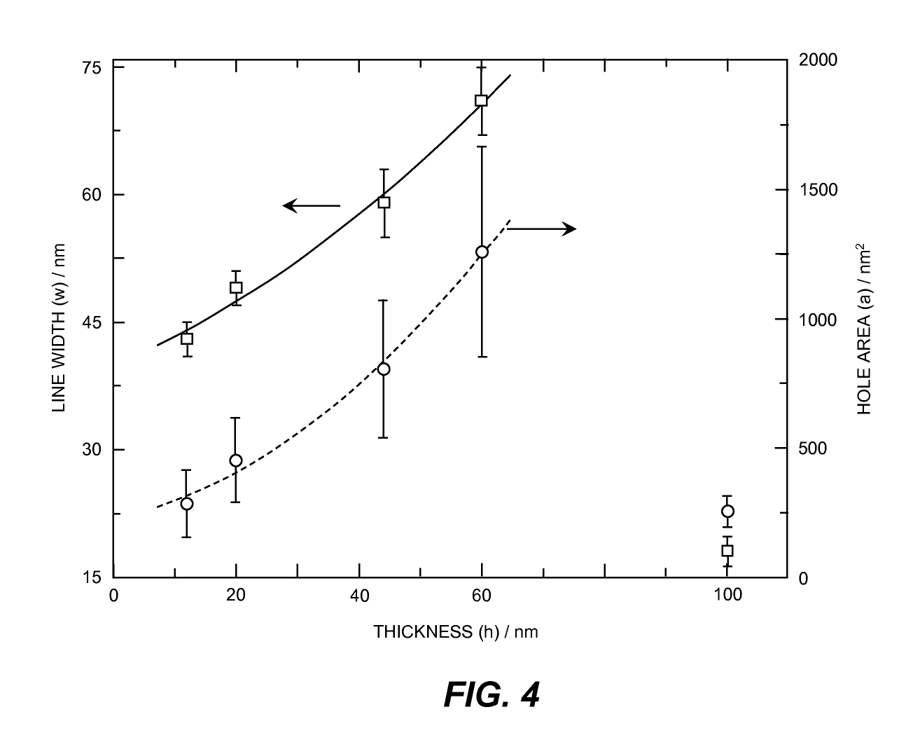

It is known that the size of features formed during dewetting depends on the film thickness. FIG. 4 shows the increase in feature sizes with increasing film thicknesses. Patterning was conducted with PS films of different thickness spun cast on HMDS-treated Si at 25° C. It should be noted that holes and trenches were only formed when using sharp tips and films of less than 60 nm thickness. It was found that a flat-topped mould containing 20 nm lines on a 100 nm pitch did not produce any pattern under the conditions used to produce the dewetting patterns shown above (i.e. 12-100 nm thick PS films, room temperature, 5 bar). It was also observed that the pattern produced by sharp tips did not reach the substrate when 100 nm thick PS films were used. In those experiments, trenches or holes were found with feature sizes more commensurate with the tip dimensions (˜12-20 nm) and these patterns almost disappeared when the films were annealed at 120° C. as a result of viscous flow and relaxation process in the mobile polymer film.

A number of other experiments were performed to investigate the limits of the pressure induced instability patterning procedure. In thin film studies, the surface wettability and film-substrate interactions are of crucial importance. It was found that thin PS films could not be patterned on oxygen-plasma-treated Si substrates using room temperature imprinting conditions, reflecting the increased stability of PS films on SiO₂. We measured contact angles of water and PS toluene solution on oxygen-plasma treated Si wafers (14.5±4° and 3.1±1°, respectively), which are much lower than the corresponding values for HMDS-Si (110.8±5° and 45.3±4°, respectively). These results indicate that the dewetting pattern size could be tuned further by altering the surface chemistry using functional silanes.

The results discussed above are all obtained using PS with Mw (molecular weight) ˜50 k. To investigate the effect of polymer Mw on this dewetting patterning, ˜30 nm thick PS films of Mw of 10.2 k, 113.5 k and 990.5 k were patterned by this approach. It was found that the PS-10.2 k film gave clear patterns under the same patterning conditions, while PS-990.5 k barely showed dewetting patterns at room temperature due to its good film stability and high viscosity. These results are in line with other published results that polymer film with low molecular weight are more easily destabilized than that with high molecular weight. Additionally, the spincoating solvent also has an effect on the dewetting patterning process, as high boiling point solvents dry more slowly, allowing more strain relaxation, resulting in finer dewetting features.

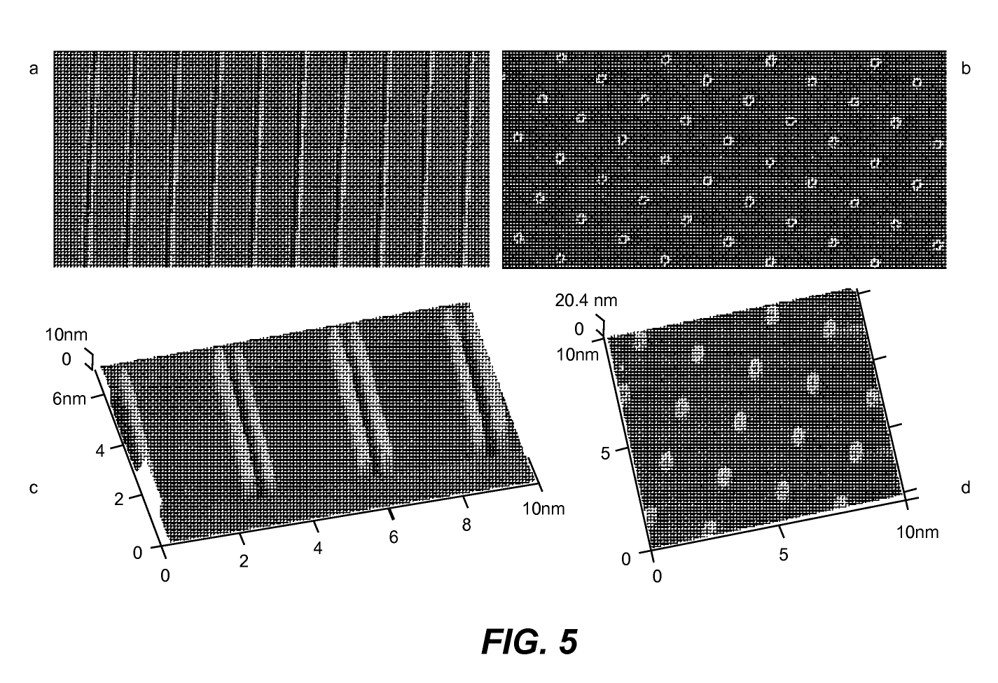

Since instabilities are a universal phenomenon of polymer film, the technique of the present invention is applicable to many polymers. Here we demonstrate the line and hole patterns in a conjugated polymer, poly(3-hexylthiophene), P3HT (Mw 87K), and a more typical polymer poly(methyl methacrylate), PMMA, Mw 120 k (FIG. 5). Very uniform, 98 nm wide trenches were formed in 38 nm thick P3HT at 100° C. with pressure of 5 bar for 50 s. Likewise, regular 28 nm wide holes (measured at the hole bottom) were produced in 60 nm thick PMMA film at 25° C. with pressure of 5 bar for 50 s.

It has been demonstrated how the residual stresses in spincoated films, which so easily lead to undesirable rupturing of thin polymer films at elevated temperatures, can be exploited to produce highly controlled nanoscale patterns using pressure induced local rupturing. The technique not only allows a systematic study of the properties of non-annealed films, but also serves as an important lithographic tool in that no residue is left in the patterned areas. The sizes of the holes and trenches formed here can be tuned by controlling the film thickness, substrate wettability, patterning temperature and post annealing time (the latter not shown above, but annealing of the films above the glass transition temperature T_{g} obviously leads to a further retraction of the films and coarsening of the holes).

The rupturing induced by pressure through a sharp tip array is in contrast to ‘classical’ dewetting or cavitation studies, which take place at temperatures above the glass transition temperature T_{g}. Likewise, NIL is usually carried out at high temperatures and high pressure (10-40 bars). The very sharp tips used here lead to very rapid pattern formation (seconds rather than minutes) in films at room temperature (or slightly above) and at low pressures (3-5 bar) (although the local pressure under the sharp tips will be much higher). In further contrast to standard NIL is the absence of a residual ‘skim’ layer, which obviates the need for an additional dry-etching step before metallization or other evaporation processes that are part of device fabrication procedures.

Apart from the method of fabrication of relief patterns, the experiments should also be of relevance for polymer electronics studies, where spincoating is used as a standard fabrication tool, but where the residual stresses might well impact film morphology and hence device performance.

### Experimental Data

Silicon substrates were cleaned in DI water, acetone, iso-propynol sonicate bath for 15 min each before use. Subsequently, the silicon substrates were coated with HMDS self-assembly monolayer (SAM) by vapor phase deposition at 175° C. (temperature) for 15 min, following 30-second oxygen plasma (power 100 w) treatment. Note that power and time of oxygen plasma treatment and HMDS treatment time were adjusted to make the silicon surface not too non-wettable, for the purpose of spincoating continuous polystyrene (PS) films possible on HMDS treated silicon substrates. In the case of very hydrophobic HMDS SAM coated silicon substrates on which continuous PS film can not be formed by spincoating, short radiation (30˜60 s) of the HMDS wafer with UV-Ozone light was used to desorb some of the HMDS molecules to allow PS films to be spun cast onto such surfaces. Contact angles were measured using a home built contact angle rig fitted with a microscope and camera. The roughness of the HMDS layers and of the PS films, as determined by atomic force microscopy (AFM) was below 1 nm.

Polystyrene (PS, Mw 50K, PolyScience Inc.) films of certain thickness were spun cast from toluene solution of various concentration onto fresh HMDS-treated, oxygen-plasma-treated and untreated silicon substrates with different spin speeds. Cleaning and coating were performed in a class 100 clean room. Patterning was performed on freshly prepared PS films stored in ambient atmosphere and, for the control experiment, dried PS films by vacuum annealing at 80° C. for 48 hours. Thickness was checked by an Alpha-SE Spectroscopic Ellipsometer and Dektek Profilometer. 10, 20, 40, 60 and 100 nm thick PS films (Mw 50K), and also 20-30 nm thick film made from polystyrene of Mw of 10.2 k, 113.5 k, and 990.5 k were studied in this work. The glass transition temperatures of the polymer thin films that were used were measured by Alpha-SE Spectroscopic Ellipsometer.

The one dimensional V-shaped tip array had a period of 3 μm. The two dimensional tip array had a diagonal period of 2.12 μm. The tip heights of 1.5 μm and 0.3-0.5 μm are much larger then the polymer film thickness of 10-60 nm. Both of them have a radius of curvature less than or equal to 10 nm. We did not observe significant signs of wear of the sharp masters after tens of patterning experiments.

The patterning process was conducted using a nanoimprinter (Obducat) at room temperature (constant at 25° C. in clean room) or various elevated temperatures (35, 45, 55, 75, 95 and 115° C.) with applied force of 3-5 bars for 10-40 seconds. The sample plate of the nanoimprinter was pre-heated to the temperature that would be used for imprinting and the instability patterning took place after the sample (Silicon tip master covered PS film on silicon substrate) was placed onto a pre-heated plate. Post thermal annealing for pattern size tuning was undertaken at 120° C. for 1-30 min.

The pattern morphologies were checked by Scanning Electron Microscope (Leo Variable pressure SEM) and Atomic Force Microscope (Dimension 3100 AFM). All the pattern widths and diameters were measured at the trench and hole bottoms and average values were taken from at least ten measurements.

The invention has been described in detail with reference to preferred embodiments thereof. It will be understood by those skilled in the art that variations and modifications can be effected within the scope of the invention. In particular there is the potential of adding pinning features and the extension to roll-to-roll NIL systems which could conceivably be co-located with the coating and drying stages of the process, the inclusion of appropriate UV curing initiators, and the use of arbitrary sharp tipped or edged patterns, be they fabricated in silicon or other stamp materials. In addition the resulting pattern could be transferred onto a further substrate to act as a receiver.

1. A method of forming a relief pattern on the surface of a substrate comprising the steps of providing a substrate, coating a thin layer of polymeric material onto the substrate, drying the polymeric material leaving residual lateral stress within the material, bringing a patterned stamp into contact with the polymeric material, applying pressure to the stamp such that the polymeric material ruptures patternwise and dewets at the surface of the substrate to form openings in the polymeric layer according to the pattern on the stamp.

2. A method of claim 1 wherein the layer of polymeric material has a thickness of less than 100 nm,

3. A method of claim 1 wherein the layer of polymeric material has a thickness of between 10 nm and 60 nm.

4. A method of claim 1 wherein the temperature of the layer of polymeric material is below glass transition temperature at the time of the stamp being brought into contact therewith.

5. A method of claim 1 wherein the patterned stamp is provided with tapered edges

6. A method of claim 1 wherein the stamp is provided with an array of pinning points on the surface thereof to limit dewetting.

7. A method of claim 1 wherein the polymeric material is chosen from polystyrene, PMMA or P3HT.

8. A method of claim 1 wherein crosslinking agents and/or UV or curing agents are added to the polymeric material prior to the patterned stamp coming into contact therewith.

9. A method of claim 1 wherein the surface of the substrate has an average roughness of 5 nm, preferably less than 1 nm.

10. A method of claim 1 wherein the relief pattern is transferred to a receiver substrate.
